(19) United States
(12) Patent Application Publication
(10) Pub. No.: US 2003/0075499 A1
(43) Pub. Date: Apr. 24, 2003

(54) Robison disposable filter element

(76) Inventor: Steven A. Robinson, Meeker, CO (US)

Correspondence Address: Steve A. Robison, PO #1138, Meeker, CO, 81641, US

(21) Appl. No.: 09/904,339

(22) Filed: Oct. 19, 2001

(51) Int. Cl. B01D 24/02; B29D 23/00; B01D 27/00; B01D 29/00; B01D 29/31; B01D 39/00; B01D 24/00; B01D 39/14

(52) U.S. Cl. 210/483; 428/34.1; 428/74; 210/500.1; 210/502.1

(57) ABSTRACT

The element consists of an outer skin, in which to house the actual filtration fiber. The skin is of sufficient integrity to confine the filtration fiber, not deteriorate, and maintain pliability, with a working temperature range of thirty-five degrees through Four hundred degrees Fahrenheit, and five to thirty pounds per square inch pressure. The filtration fiber(s) can be manipulated to perform specific tasks, for instance: the regulation or removal of water within an ethylene glycol system, or, with introduction of water the micronal capacity may be regulated.

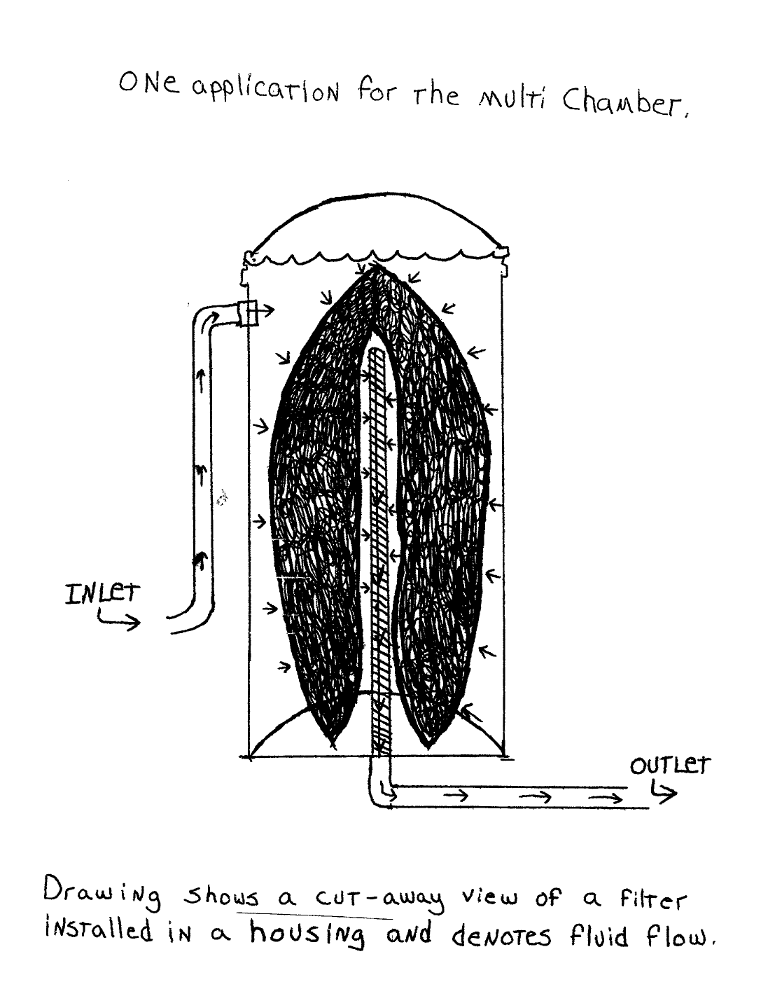

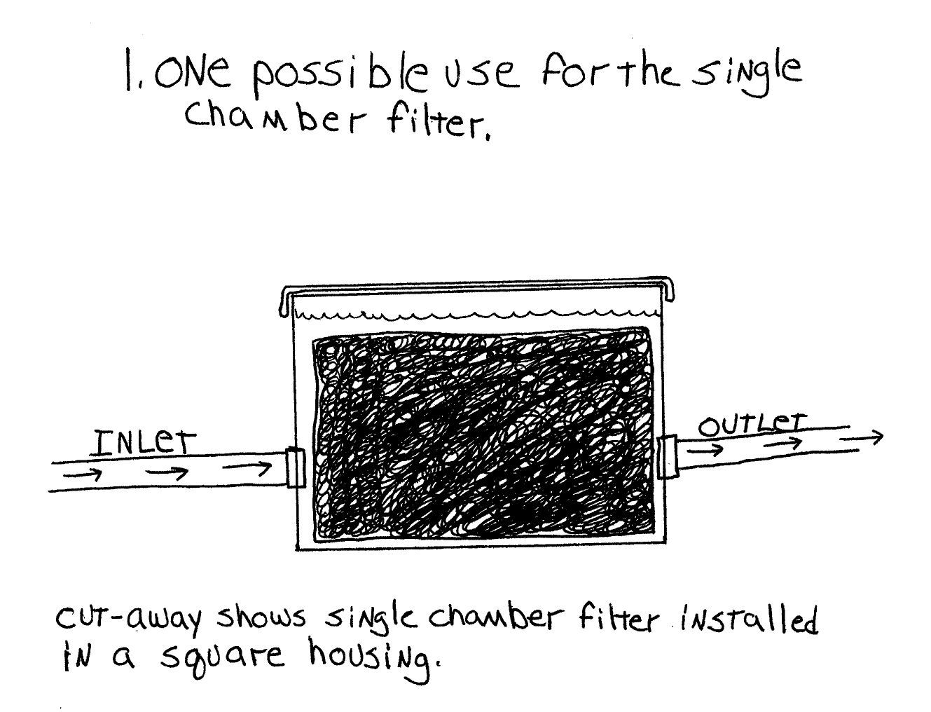

The element is comprised of three main components.

The outer skin, (which can be tailored to most any size or shape, depending upon the particular needs of the consumer) is a pliable fabric which consists of, but is not limited too, one or more of the following:

a. cotton

b. wool

c. jute

d. hemp

e. nylon

f. polyester

g. dacron

the material used is partly determined by the temperature range of operation, (for instance, the man-made fabrics are effective only through two hundred degrees Fahrenheit).

Secondly is the filling or fiber which is confined by the skin. This consists of one or more of the afore mentioned materials. The material is inserted (packed to degree desired) into the skin enclosure, which is then sewn shut to confine the fiber. The fiber is to be determined by temperature range, desired micronal capacity, as well as the need (if any) to regulate the level of water within the system.

Third is the thread with which the skin is sewn together. As with the other two components, the thread will consist of the afore mentioned materials, with the addition of fiberglass and, or Kevlar, depending upon application.

1. The element is a disposable, non-rigid, single or multi-chambered filter, constructed of man-made and/or natural skin, and man-made or natural filling within the chambers.

2. The materials of construction for both the skin and the the filling include but are not limited to the following:
a. cotton
b. wool
c. jute
d. hemp
e. nylon
f. polyester
g. Dacron

3. The filling is then either loosely packed into the chamber or loosely woven in a mat form and inserted into the chambers slightly packed.

4. The element is constructed by fitting, cutting, and sewing with industrial grade equipment, the aforementioned materials, in such a way that it may be inserted into a housing through-which various types of fluids may be pumped.

5. The performance of the element is determined by the materials or combination of materials used.

6. When natural filling and/or skin materials are used the benefit is dual in that, with the absorption of water the fibers swell and are able to retain smaller particles of unwanted material.

7. The elements are typically used to filter ethylene glycol, and other Industrial fluids.
